(19) United States
(12) Patent Application Publication
(10) Pub. No.: US 2014/0372199 A1
(43) Pub. Date: Dec. 18, 2014

(54) ELECTRONIC COUPON SYSTEM

(71) Applicant: Ichiro Konno, Osaka-shi (JP)

(72) Inventor: Ichiro Konno, Osaka-shi (JP)

(73) Assignee: SHARP KABUSHIKI KAISHA, Osaka-shi, Osaka (JP)

(21) Appl. No.: 14/373,545

(22) PCT Filed: Aug. 28, 2012
(86) PCT No.: PCT/JP2012/071645

§ 371 Date: Jul. 21, 2014

(30) Foreign Application Priority Data
Jan. 31, 2012 (JP) 2012-017906

(51) Int. Cl. G06Q 30/02

(52) U.S. Cl. CPC G06Q 30/0238
USPC 705/14.38

(57) ABSTRACT

Provided is an electronic coupon system capable of saving, in a mobile information terminal, electronic coupons having high likelihood of being used by a user, from among electronic coupons delivered by digital broadcast radio waves, whereby the user can use the electronic coupons without forgetting. The electronic coupon system (10): automatically obtains filter information from operation information, etc., for a broadcast reception terminal (100) or a mobile information terminal (200); extracts, from a lot of electronic coupons, only electronic coupons that have high likelihood of being used by the user; and saves them in the mobile information terminal (200) of the user. If the user approaches a store (14) where an electronic coupon can be used, an electronic coupon available at the store (14) is transmitted from a store coupon information processing terminal (300) to the mobile information terminal (200), and the user can use the electronic coupon without forgetting.

### TECHNICAL FIELD

The present invention relates to an electronic coupon that is delivered by a broadcast signal, and particularly relates to an electronic coupon system capable of improving use of an electronic coupon.

### BACKGROUND ART

As an electronic coupon system using a mobile information terminal such as a mobile phone, a method for acquiring an electronic coupon from an electronic mail or the Web and presenting the electronic coupon at a store or the like to thereby receive a discount and the like is realized. In the method using an electronic mail, however, a provider of an electronic coupon is required to ask a customer to register an electronic mail address in advance. Further, in the method using the Web, since a customer searches an electronic coupon on the Web so that the customer acquires the electronic coupon, a provider of the electronic coupon is not able to provide the electronic coupon to unspecified number of customers. Therefore, an electronic coupon system has been proposed that delivers an electronic coupon by digital broadcast radio waves for receiving the electronic coupon through a television receiver (hereinafter, referred to as broadcast reception terminal) that receives these digital broadcast radio waves. In such an electronic coupon system by the digital broadcast radio waves, however, a lot of electronic coupons are delivered to the broadcast reception terminal, so that filtering processing for extracting only an electronic coupon that is usable by a customer becomes necessary.

As a technology for delivering an electronic coupon by terrestrial digital broadcasting, PATENT LITERATURE 1 and PATENT LITERATURE 2 below are cited. Provided in PATENT LITERATURE 1 is a broadcast system in which a form for discriminating data of an electronic coupon and the like is transmitted from a broadcasting station, and a viewer sets discriminative information in accordance with the form, thus making it possible to acquire an electronic coupon suitable for the viewer from among electronic coupons to be broadcasted. Further, provided in PATENT LITERATURE 2 is a digital television broadcast system in which index information for selecting or omitting electronic coupons transmitted from a broadcasting station is added to an electronic coupon, and using personal information of a viewer and the added index information, the electronic coupon suitable for preference of the viewer is displayed on a television or transferred to a mobile terminal.

### CITATION LIST

### Patent Literatures

PATENT LITERATURE 1: Japanese Patent No. 4757999
PATENT LITERATURE 2: Japanese Laid-Open Patent Publication No. 2002-101359

### SUMMARY OF INVENTION

### Technical Problem

In such electronic coupon systems using terrestrial digital broadcasting of PATENT LITERATURE 1 and PATENT LITERATURE 2, an electronic coupon having a high likelihood of being used by a user is able to be subjected to filtering to be extracted from a lot of electronic coupons. However, since a user needs to input filtering information by himself/herself in both PATENT LITERATURE 1 and PATENT LITERATURE 2, when a store or a service having a high likelihood of being used by the user changes, the user needs to change the filtering information by himself/herself, thus posing a problem of requiring labor. Further, there is a case where the user, even if acquiring an electronic coupon in advance and saving it in a mobile information terminal or the like, forgets to present the electronic coupon at a store where the electronic coupon is usable and does not use the electronic coupon.

The present invention has been made in view of such circumstances, and aims to provide an electronic coupon system capable of solving the above-described problem.

### Solution to Problem

An electronic coupon system of the present invention is an electronic coupon system, comprising a broadcast reception terminal, a store coupon information processing terminal and a mobile information terminal, and is characterized in that the broadcast reception terminal has coupon information extraction means for extracting coupon information of electronic coupons from a broadcast signal, filtering means for filtering the electronic coupons, and coupon information transmission means for transmitting the coupon information of the electronic coupons subjected to filtering by the filtering means to the mobile information terminal, the store coupon information processing terminal has store coupon information transmission means for transmitting store coupon information to the mobile information terminal, and the mobile information terminal has store coupon information display means for displaying the store coupon information on the mobile information terminal when the coupon information received from the broadcast reception terminal and the store coupon information received from the store coupon information processing terminal are matched.

Moreover, it is characterized in that the filtering means of the electronic coupon system of the present invention sets points for each of the electronic coupons based on filter information acquired from the broadcast reception terminal and the mobile information terminal, and performs filtering of the electronic coupons based on the points.

Moreover, the electronic coupon system of the present invention is characterized in that a weight rank is set to the filter information, and the points of the electronic coupons are calculated by the weight rank.

Moreover, it is characterized in that the store coupon information processing terminal of the electronic coupon system of the present invention transmits a connection request to the mobile information terminal, the mobile information terminal receives the connection request from the store coupon information processing terminal, and when authentication is completed, the store coupon information processing terminal and the mobile information terminal are connected.

Moreover, it is characterized in that the store coupon information processing terminal and the mobile information terminal of the electronic coupon system of the present invention are connected by short distance wireless communication means.

Moreover, it is characterized in that authentication of the store coupon information processing terminal and the mobile information terminal of the electronic coupon system of the present invention is performed by collation of passkey information set to the coupon information and passkey information set to the store coupon information.

Moreover, it is characterized in that whether the coupon information and the store coupon information are matched is judged in the electronic coupon system of the present invention by collation of the passkey information.

Moreover, it is characterized in that the passkey information of the coupon information of the electronic coupon system of the present invention is generated from the coupon information.

Moreover, it is characterized in that the passkey information of the store coupon information of the electronic coupon system of the present invention is generated from the store coupon information.

Moreover, it is characterized in that the mobile information terminal of the electronic coupon system of the present invention judges whether a user of the mobile information terminal is able to use the electronic coupons with member information set to the coupon information.

### Advantageous Effects of Invention

An electronic coupon system of the present invention provides an electronic coupon system in which, as to an electronic coupon delivered by digital broadcast radio waves, even when an electronic coupon having a high likelihood of being used by a customer changes, only an electronic coupon having a high likelihood of being used by the customer is able to be extracted from the digital broadcast radio waves in accordance with the change and the electronic coupon is usable without forgetting at a store where the electronic coupon is usable by the customer.

### BRIEF DESCRIPTION OF DRAWINGS

FIG. 1 is a diagram showing an outline of an electronic coupon system according to an embodiment of the present invention.

FIG. 2 is a diagram showing a functional configuration of a broadcast reception terminal according to the embodiment of the present invention.

FIG. 3 is a diagram showing a functional configuration of a mobile information terminal according to the embodiment of the present invention.

FIG. 4 is a diagram showing a functional configuration of store coupon information processing according to the embodiment of the present invention.

FIG. 5 is a diagram showing a configuration of coupon information of an electronic coupon delivered by digital broadcast radio waves according to the embodiment of the present invention.

FIG. 6 is a diagram showing a method for generating filter information according to the embodiment of the present invention.

FIG. 7 are diagrams showing procedure of setting points of coupon information according to the embodiment of the present invention.

FIG. 8 is a flowchart of coupon information saving processing in the mobile information terminal according to the embodiment of the present invention.

FIG. 9 is a flowchart of store coupon information transmission processing in a store coupon information processing terminal according to the embodiment of the present invention.

FIG. 10 is a flowchart of coupon information display processing in the mobile information terminal according to the embodiment of the present invention.

### DESCRIPTION OF EMBODIMENTS

Hereinafter, description will be given for a mode for carrying out the present invention (hereinafter, referred to as “embodiment”) with reference to drawings. An electronic coupon system 10 of the present invention automatically acquires information for filtering electronic coupons (hereinafter, referred to as filter information) from information acquired when a broadcast reception terminal or a mobile information terminal is operated (hereinafter, referred to as operation information) or the like, extracts only an electronic coupon having a high likelihood of being used by a customer from a lot of electronic coupons delivered by digital broadcast radio waves with these filter information, and saves it in the mobile information terminal of the customer. Further, if the customer, being in possession of the mobile information terminal in which the electronic coupon is saved, approaches a store where a service of the electronic coupon is able to be received, information about a coupon set to the electronic coupon (hereinafter, referred to as coupon information) is notified to the mobile information terminal.

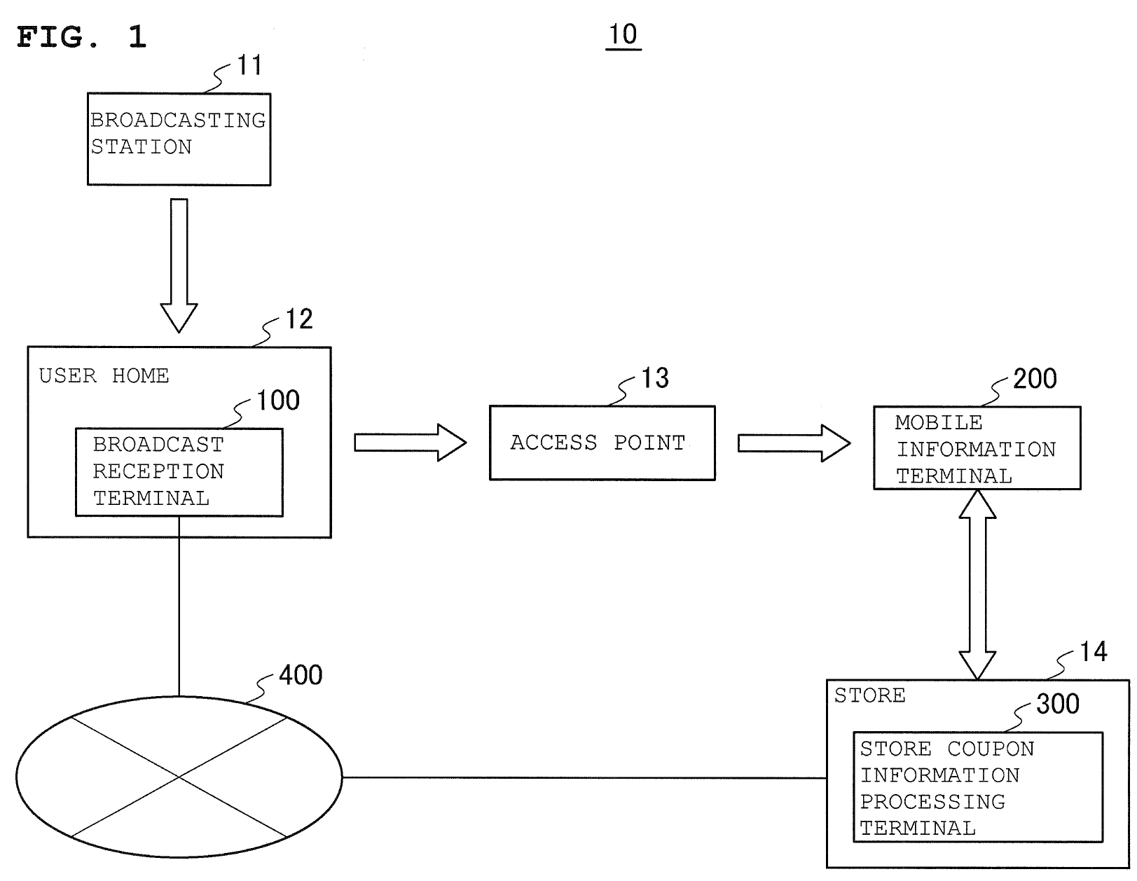

Description will be given for an outline of the electronic coupon system 10 of the present embodiment using FIG. 1. The electronic coupon system 10 is configured by, as shown in FIG. 1, a broadcast reception terminal 100 that receives digital broadcast radio waves of a broadcasting station 11, a mobile information terminal 200 that is possessed by a customer (hereinafter, referred to as user) targeted for delivering of an electronic coupon and is capable of performing wireless communication with the broadcast reception terminal 100, and a store coupon information processing terminal 300 that is capable of performing wireless communication with the mobile information terminal 200. The broadcast receiver 100 is installed in a user home 12 or the like, and the store coupon information processing terminal 300 is installed in a store 14. Moreover, the broadcast reception terminal 100 is connected to a network 400 via a provider or the like, and the broadcast reception terminal 100 and the mobile information terminal 200 are able to perform wireless communication by an access point 13 installed in the user home 12 or outdoor. In the electronic coupon system 10 shown in FIG. 1, though each of the broadcasting station 11, the user home 12, the access point 13 and the store 14 is described for one location, the broadcasting station 11, the user home 12, the access point 13 and the store 14 exist in a plurality of locations actually. Further, though the mobile information terminal 200 is also described by one piece, a plurality of mobile information terminals 200 are able to be provided. In such a case, the broadcast reception terminal 100 is able to be operated from the plurality of mobile information terminals 200, and the plurality of mobile information terminals 200 are able to perform wireless communication with the broadcast reception terminal 100.

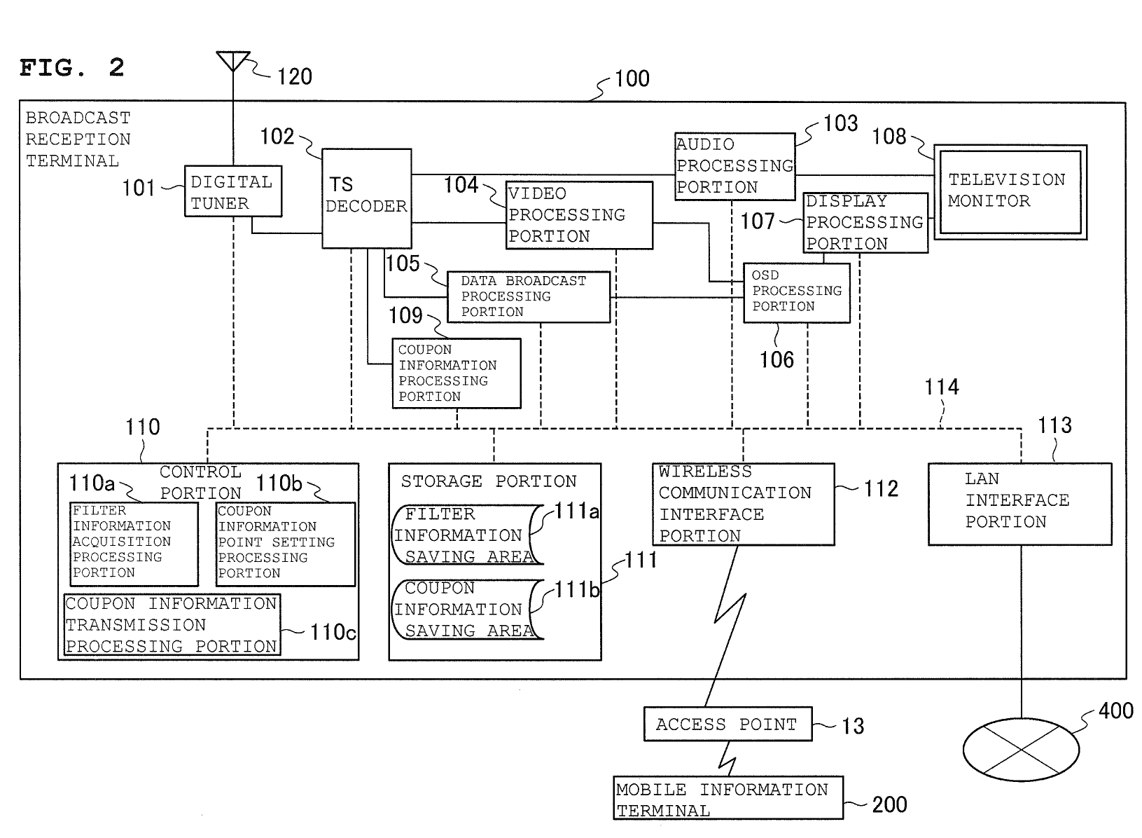

Next, description will be given for a functional configuration of the broadcast reception terminal 100 using FIG. 2. As shown in FIG. 2, the broadcast reception terminal 100 is configured by a digital tuner 101, a TS (Transport Stream) decoder 102, an audio processing portion 103, a video processing portion 104, a data broadcast processing portion 105, an OSD processing portion 106, a display processing portion 107, a television monitor 108, a coupon information processing portion 109, a control portion 110, a storage portion 111, a wireless communication interface portion 112, a LAN interface portion 113, and a system bus 114. The control portion 110 is provided with a filter information acquisition processing portion 110a, a coupon information point setting processing portion 110b, and a coupon information transmission processing portion 110c. The storage portion 111 is provided with a filter information saving area 111a and a coupon information saving area 111b.

An antenna 120 that receives digital broadcast radio waves is connected to the digital tuner 101, and the digital tuner 101 inputs the digital broadcast radio waves from this antenna 120 and demodulates these broadcast radio waves into a transport stream packet (TS packet) to output to the TS decoder 102. The TS decoder 102 extracts, from this TS packet, a video and audio stream of desired program broadcasting, data broadcasting, and coupon information of electronic coupons. The video and audio stream of the desired program broadcasting, the data broadcasting information, and the coupon information of electronic coupons, which are extracted, are digital data coded by MPEG-2. The audio processing portion 103 decodes audio data from the coded video and audio stream and outputs the decoded audio data to the television monitor 108. The video processing portion 104 decodes video data from the coded video and audio stream and outputs the decoded video data to the OSD processing portion 106. Upon input of a data broadcast display command output from the control portion 110, the data broadcast processing portion 105 decodes the coded data broadcasting information and sets the decoded data broadcasting information to a data broadcast area to output to the OSD processing portion 106. The OSD processing portion 106 superimposes the video data output from the video processing portion 104 with the data broadcast area output from the data broadcast processing portion 105, and outputs the superimposed data to the display processing portion 107. The display processing portion 107, when receiving the data in which the video data and the data broadcast area are superimposed from the OSD processing portion 106, performs conversion into a television signal to output to the television monitor 108. When the video data and the data broadcast area are superimposed in this manner, both a television broadcast screen and a data broadcast screen are displayed on the television monitor 108. Further, upon input of the audio data from the audio processing portion 103, the television monitor 108 outputs sound from a speaker provided in the television monitor 108. The coupon information processing portion 109 decodes the coded coupon information of electronic coupons and outputs the decoded coupon information of electronic coupons to the control portion 110. A configuration of the coupon information of electronic coupons delivered by digital broadcast radio waves will be described below.

The control portion 110 controls the entire broadcast reception terminal 100 while switching broadcast channels and data broadcasting based on an operation signal of the mobile information terminal 200 by a user. The filter information acquisition processing portion 110a of the control portion 110 acquires filter information for extracting only an electronic coupon having a high likelihood of being used by the user as to electronic coupons delivered by digital broadcast radio waves. Moreover, the filter information acquisition processing portion 110a saves the acquired filter information in the filter information saving area 111a of the storage portion 111. The filter information will be described specifically below. Upon input of the decoded coupon information of electronic coupons from the coupon information processing portion 109, the coupon information point setting processing portion 110b of the control portion 110 performs setting of points to the coupon information of the electronic coupons based on the filter information saved in the filter information saving area 111a of the storage portion 111. In addition, the coupon information point setting processing portion 110b saves the coupon information of the electronic coupons to which points are set in the coupon information saving area 111b of the storage portion 111. Procedure of point setting performed by the coupon information point setting processing portion 110b will be described below. The coupon information transmission processing portion 110c extracts the coupon information from the coupon information saving area 111b of the storage portion 111 with a constant period to transmit to the mobile information terminal 200 via the wireless communication interface portion 112 in the order of high points set to the coupon information. Moreover, after extracting the coupon information from the coupon information saving area 111b of the storage portion 111 to transmit to the mobile information terminal 200, the coupon information transmission processing portion 110c deletes the coupon information. In this manner, the coupon information point setting processing portion 110b sets points to the coupon information of the electronic coupons based on the filter information acquired by the filter information acquisition processing portion 110a and the coupon information transmission processing portion 110c transmits coupon information of an electronic coupon having a predetermined point value or more to the mobile information terminal 200, so that the mobile information terminal 200 is able to receive only coupon information of an electronic coupon having a high likelihood of being used by the user, which is subjected to filtering.

The storage portion 111 stores a program for realizing a basic function of the broadcast reception terminal 100. Filter information for filtering electronic coupons is saved in the filter information saving area 111a of the storage portion 111. Coupon information of an electronic coupon to which points are set is saved in the coupon information saving area 111b of the storage portion 111. The wireless communication interface portion 112 receives a wireless signal such as an operation signal transmitted from the mobile information terminal 200 using wireless communication means via the access point 13 and outputs the operation signal to the control portion 110. The LAN interface portion 113 is connected to the network 400 via a provider or the like with a LAN cable, and is able to access an HP (homepage) and a shopping site of the store 14 through the network 400. The system bus 114 connects the control portion 110 and each portion which is controlled by the control portion 110 and the control portion 110 outputs a control signal to each portion via the system bus 114.

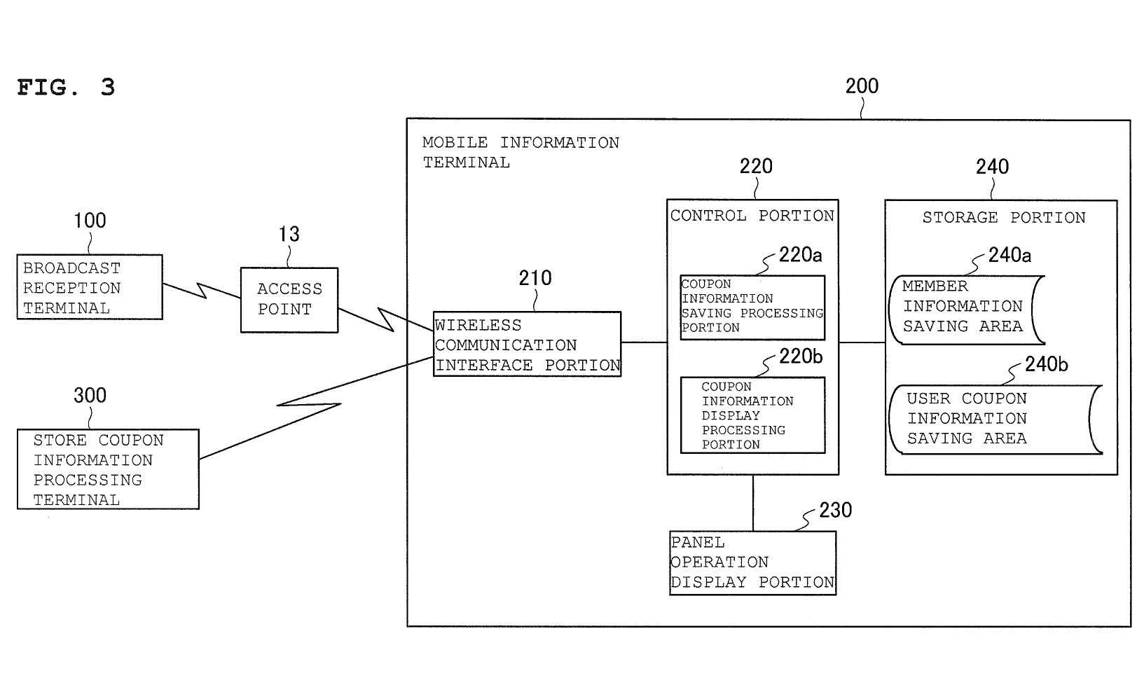

Next, description will be given for a functional configuration of the mobile information terminal 200 using FIG. 3. As shown in FIG. 3, the mobile information terminal 200 is configured by a wireless communication interface portion 210, a control portion 220, a panel operation display portion 230 and a storage portion 240. Moreover, the control portion 220 is provided with a coupon information saving processing portion 220a and a coupon information display processing portion 220b. The storage portion 240 is provided with a member information saving area 240a and a user coupon information saving area 240b. The wireless communication interface portion 210 receives a wireless signal transmitted from the broadcast reception terminal 100 using wireless communication means via the access point 13 to output to the control portion 220. The control portion 220 controls the entire mobile information terminal 200. The coupon information saving processing portion 220a of the control portion 220 saves coupon information of electronic coupons subjected to filtering, which is transmitted from the broadcast reception terminal 100, in the user coupon information saving area 240b of the storage portion 240. The coupon information saving processing portion 220a will be specifically described below. The coupon information display processing portion 220b of the control portion 220 confirms whether coupon information matching coupon information transmitted from the store coupon information processing terminal 300 (hereinafter, referred to as store coupon information) is saved in the user coupon information saving area 240b of the storage portion 240, and when being saved, displays it on a panel of the panel operation display portion 230. The store coupon information is information of electronic coupons on the side of the store 14, in which detailed information such as service contents of the store 14 is further set to coupon information of electronic coupons delivered from the digital broadcast radio waves. The coupon information display processing portion 220b will be specifically described below. The panel operation display portion 230 is provided with a panel allowing operation by contact with a finger of a user, and displays operation items of functions included in the mobile information terminal 200 on the panel and displays input of an operation from the panel and data and information received via the access point 13 on the panel. Moreover, notification permission of coupon information of electronic coupons received by the mobile information terminal 200 is set to the panel operation display portion 230 by the user. The storage portion 240 stores a program for realizing a basic function of the mobile information terminal 200. Member information of the user himself/herself of the mobile terminal is saved in the member information saving area 240a of the storage portion 240. Coupon information of electronic coupons subjected to filtering at the broadcast reception terminal 100 to be transmitted is saved in the user coupon information saving area 240b of the storage portion 240.

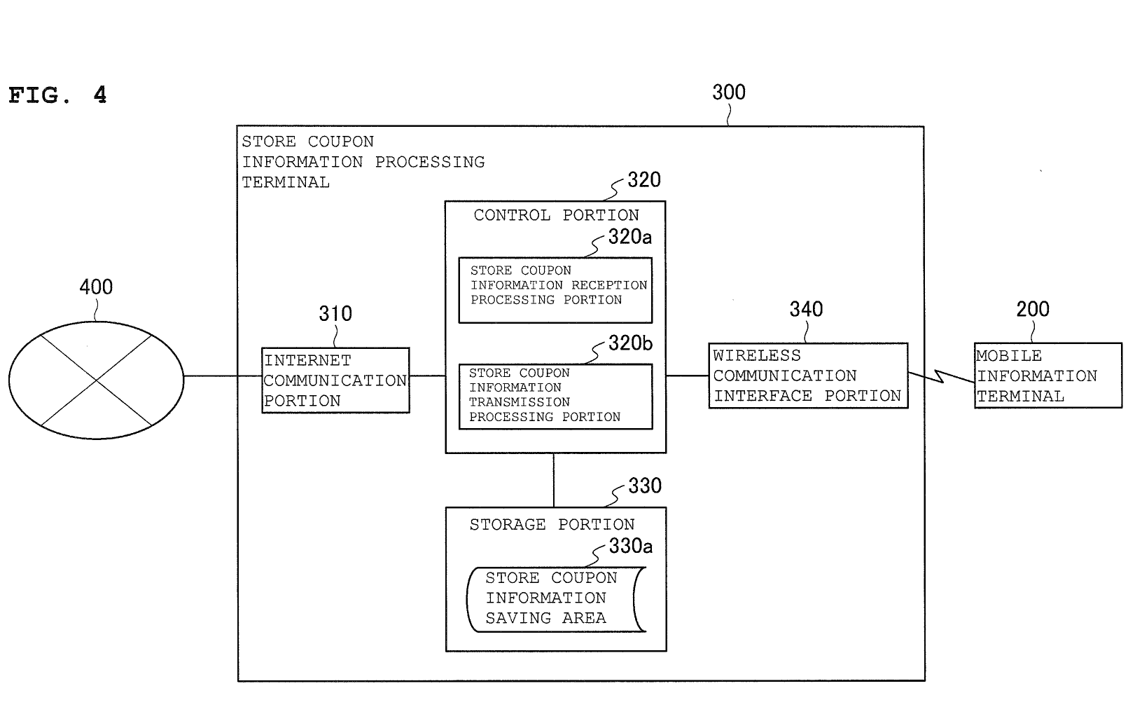

Next, description will be given for a functional configuration of the store coupon information processing terminal 300 using FIG. 4. As shown in FIG. 4, the store coupon information processing terminal 300 is configured by an internet communication portion 310, a control portion 320, a storage portion 330 and a wireless communication interface portion 340. Moreover, the control portion 320 is provided with a store coupon information reception processing portion 320a and a store coupon information transmission processing portion 320b. The storage portion 330 is provided with a store coupon information saving area 330a. The internet communication portion 310 is connected to the network 400 via a provider or the like. The control portion 320 controls the entire store coupon information processing terminal 300. The store coupon information reception processing portion 320a of the control portion 320 receives, from a server or an HP (homepage) of other stores and companies connected to the network 400 or the like, coupon information of an electronic coupon available at its own store 14 via the internet communication portion 310. Further, the store coupon information reception processing portion 320a performs saving in the store coupon information saving area 330a of the storage portion 330. An electronic coupon matching this electronic coupon is delivered by the digital broadcast radio waves to the user. While performing wireless communication with the mobile information terminal 200, the store coupon information transmission processing portion 320b of the control portion 320 judges whether the coupon information of the electronic coupon saved in the mobile information terminal 200 is available at the store 14. The store coupon information transmission processing portion 320b will be specifically described below. The storage portion 330 stores a program for realizing a basic function of the store coupon information processing terminal 300. Store coupon information available at the store 14 is saved in the coupon information saving area 330a of the storage portion 330. The wireless communication interface portion 340 receives a wireless signal transmitted from the mobile information terminal 200 by using wireless communication means having a communication allowed range that is valid in short distance communication such as Bluetooth (registered trademark) or ZigBee (registered trademark) of from around 10 m to 100 m, to output to the control portion 320. In the present invention, such wireless communication means is referred to as “short distance wireless communication means”.

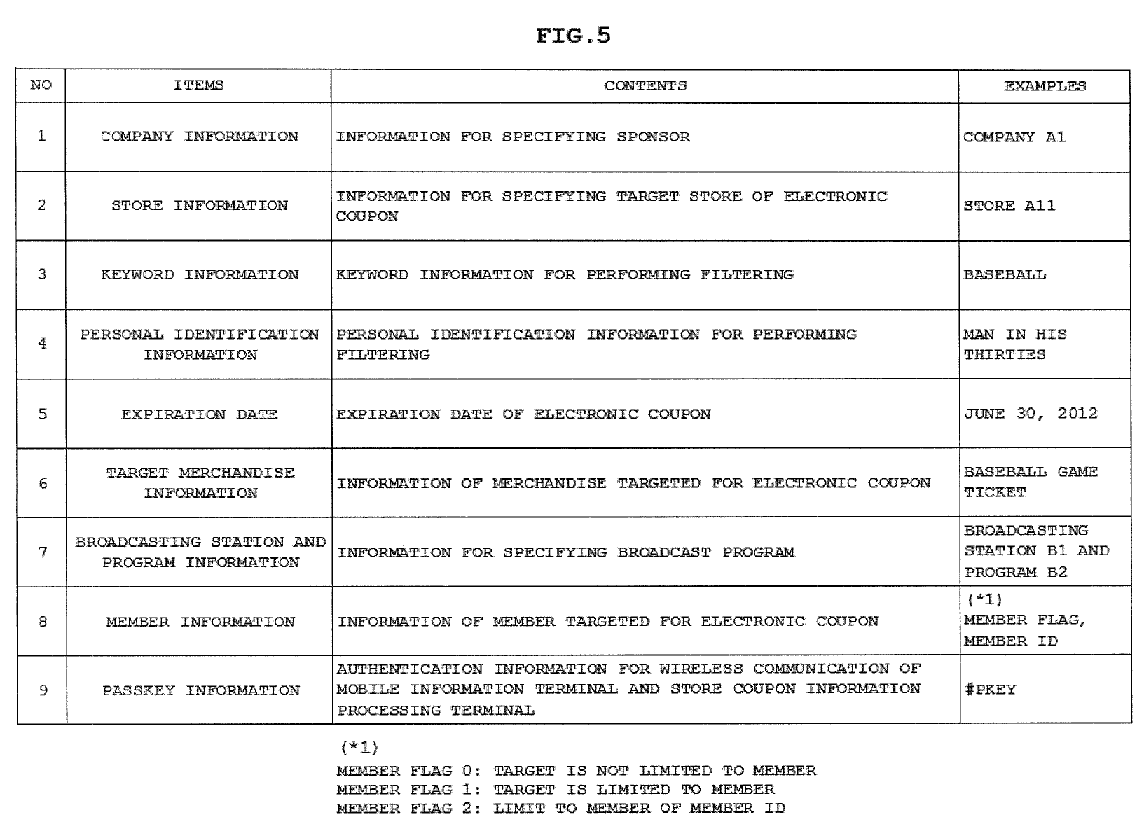

Next, description will be given for a configuration of coupon information of an electronic coupon delivered by the digital broadcast waves using FIG. 5. As shown in FIG. 5, coupon information of an electronic coupon is configured by company information, store information, keyword information, personal identification information, an expiration date, target merchandise information, broadcasting station and program information, member information and passkey information. The company information is information for specifying a company which is an issuing source of the electronic coupon. For example, when the issuing source of the electronic coupon is “company A1”, this “company A1” is set. The store information is information for specifying a store where the electronic coupon is available. For example, when the store where the electronic coupon is available is “store A12”, this “store A12” is set. The keyword information is information for specifying a keyword at a time of filtering electronic coupons using a keyword. For example, when the keyword is “baseball”, this “baseball” is set. The personal identification information is information for specifying individual at a time of filtering electronic coupons using personal information. For example, when the personal identification information is “man in his thirties”, this “man in his thirties” is set. The expiration date is an expiration date of the electronic coupon. For example, when the expiration date is “Jun. 30, 2012”, this “Jun. 30, 2012” is set. The target merchandise information is information of merchandise targeted for acquiring a discount or a privilege by the electronic coupon. For example, in a case where merchandise targeted for the electronic coupon is “baseball game ticket” and a discount is applied by the electronic coupon if this “baseball game ticket” is purchased, this “baseball game ticket” is set. The broadcasting station and program information is information for specifying a broadcasting station and a program name. For example, when the broadcasting station and program information is “broadcasting station B1 and program B2”, this “broadcasting station B1 and program B2” is set. The member information is information for limiting target persons of the electronic coupon to specific members. For example, when “0” is set to a member flag, target persons of the electronic coupon are not limited to the members. When “1” is set to the member flag, target persons of the electronic coupon are limited to the members. When “2” is set to the member flag, limiting is performed only to a member with a designated member ID. In this manner, the member flag and the member ID when the member flag is “2” are set to the member information. The passkey information is a passkey that is used as authentication information when the mobile information terminal 200 and the store coupon information processing terminal 300 perform wireless communication, and is used for judging whether the store coupon information transmitted from the store coupon information processing terminal 300 and the coupon information saved in the coupon information saving area 111b are matched by the mobile information terminal 200. For example, when the passkey is “#PKEY”, this “#PKEY” is set.

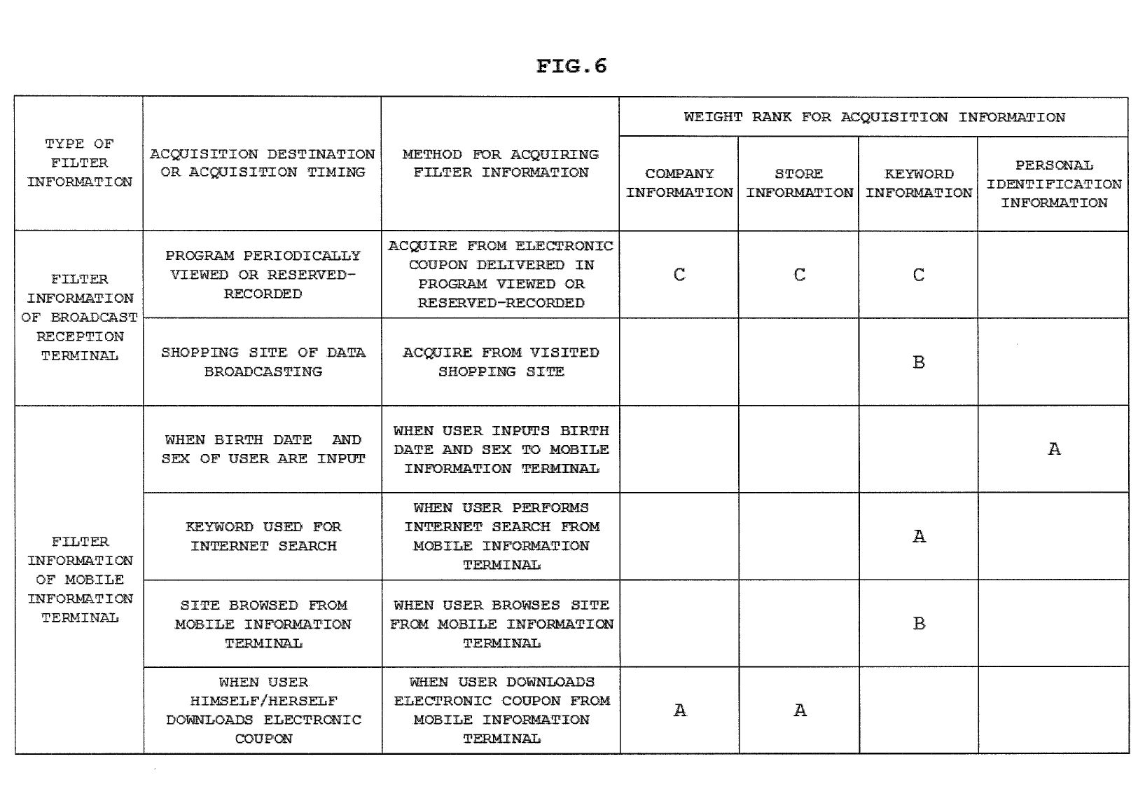

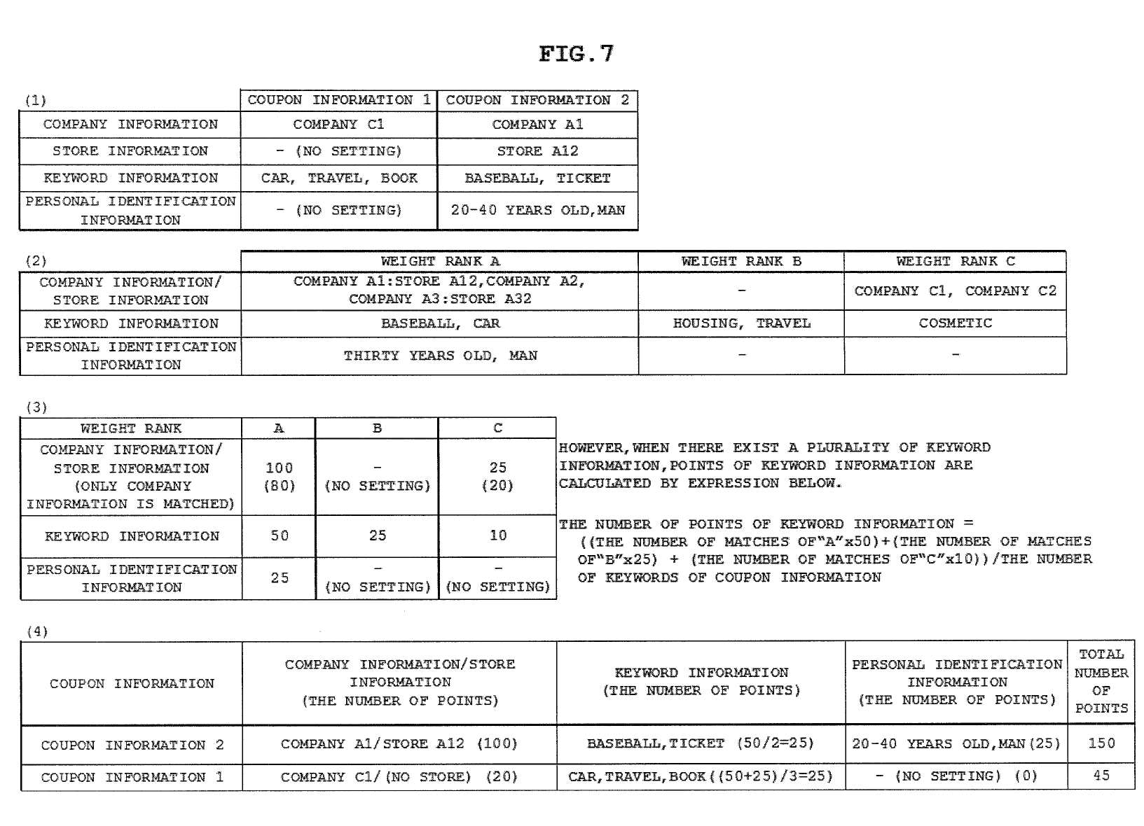

Next, description will be given for a method for generating filter information that is acquired by the filter information acquisition processing portion 110a of the broadcast reception terminal 100 and saved in the filter information saving area 111a of the storage portion 111 using FIG. 6 and FIG. 7. Filter information shown in FIG. 6 has two types of information of filter information acquired by the filter information acquisition processing portion 110 when the user performs an operation of the broadcast reception terminal 100 (hereinafter, referred to as “broadcast reception terminal filter information”) and filter information acquired by the broadcast reception terminal 100 via the wireless communication interface portion 112 when the user performs an operation of the mobile information terminal 200 (hereinafter, referred to as “mobile information terminal filter information”). Moreover, for the “broadcast reception terminal filter information” and the “mobile information terminal filter information”, “acquisition destination or acquisition timing”, “method for acquiring filter information” and “weight rank for acquisition information” are determined. The “acquisition destination or acquisition timing” is an acquisition destination or an acquiring timing of filter information. The “method for acquiring filter information” is a method for acquiring filter information at the acquisition destination or the acquiring timing. The “weight rank for acquisition information” is a weight rank for the acquired filter information. The weight rank is in the order of “A”, “B” and “C”, and the weight rank “A” is the weightiest (highest) rank. For example, when the acquisition destination or the acquisition timing is “program periodically viewed or reserved-recorded” in the broadcast reception terminal filter information of FIG. 6, “company information”, “store information” and “keyword information” are acquired as the filter information from coupon information of an electronic coupon that is delivered from a program that is periodically viewed or reserved-recorded. Then, when the weight ranks of these “company information”, “store information” and “keyword information”, which are filter information, are “C”, “C” is set to “company information”, “store information” and “keyword information” in the “weight rank for acquisition information”. Procedure of calculating points of filter information based on this weight will be described in the following coupon information point setting procedure.

Next, description will be given for the coupon information point setting procedure in which the coupon information point setting processing portion 110b of the broadcast reception terminal 100 sets points to coupon information using FIGS. 7. FIG. 7(1) shows contents of “company information”, “store information”, “keyword information” and “personal identification information” set to coupon information 1 and coupon information 2 of electronic coupons extracted from the digital broadcast radio waves by the coupon information processing portion 109. FIG. 7(2) shows a configuration of filter information saved in the filter information saving area 111a of the broadcast reception terminal 100. For the filter information, contents of “company information/store information”, “keyword information” and “personal identification information” are set for each weight rank. FIG. 7(3) shows points that are determined in advance for each weight rank with respect to “company information/store information”, “keyword information” and “personal identification information”. FIG. 7(4) is data of the coupon information 1 and the coupon information 2 saved in the coupon information saving area 111b by the coupon information point setting processing portion 110b of the broadcast reception terminal 100. Note that, when the coupon information point setting processing portion 110b saves the coupon information in the coupon information saving area 111b, the coupon information is saved in the order of high points that are set thereto.

In this manner, by saving coupon information of electronic coupons in the coupon information saving area 111b in the order of high points, when extracting coupon information of electronic coupons having the number of points determined in advance, the coupon information transmission processing portion 110c is able to easily perform extraction.

In such setting, the “company information” is “C1”, the “store information” is “no setting”, the “keyword information” is “car, travel and book” and the personal identification information is “no setting” in the coupon information 1 of FIG. 7(1). Further, according to the filter information of FIG. 7(2), “company C1” of the “company information” has the weight rank of “C”, “car” of the “keyword information” has the weight rank of “A”, and “travel” of the “keyword information” has the weight rank of “B”. In addition, according to points with respect to information for each weight rank of FIG. 7(3), points when only “company information” is matched in the weight rank “C” of the “company information/store information” are 20, so that points of the “company information/store information” in the coupon information 1 are 20. Moreover, points of the weight rank “A” of the “keyword information” are 50 and points of the weight rank “B” of the keyword information are 25. Furthermore, as to the “keyword information”, in a case where there are a plurality of keyword information in coupon information, the number of points of the weight ranks of the “keyword information” is summed and the total points are divided by the number of the “keyword information”. For example, in the coupon information 1 of FIG. 7(1), the “keyword information” has three pieces of information of “car, travel and book”. The weight rank of “car” is “A” and therefore points are 50, the weight rank of “travel” is “B” and therefore points are 25, and “book” is not set in the filter information and therefore points are 0. As a result of this, the total points of the “keyword information” in the coupon information 1 is (50+25)/3=25. Accordingly, points of the coupon information 1 are 45 points as a total of 20 points of the “company information/store information” and 25 points of the “keyword information”. Note that, in the coupon information 1 and the coupon information 2, the coupon information 2 has higher points than the coupon information 1, so that the coupon information 2 is saved high.

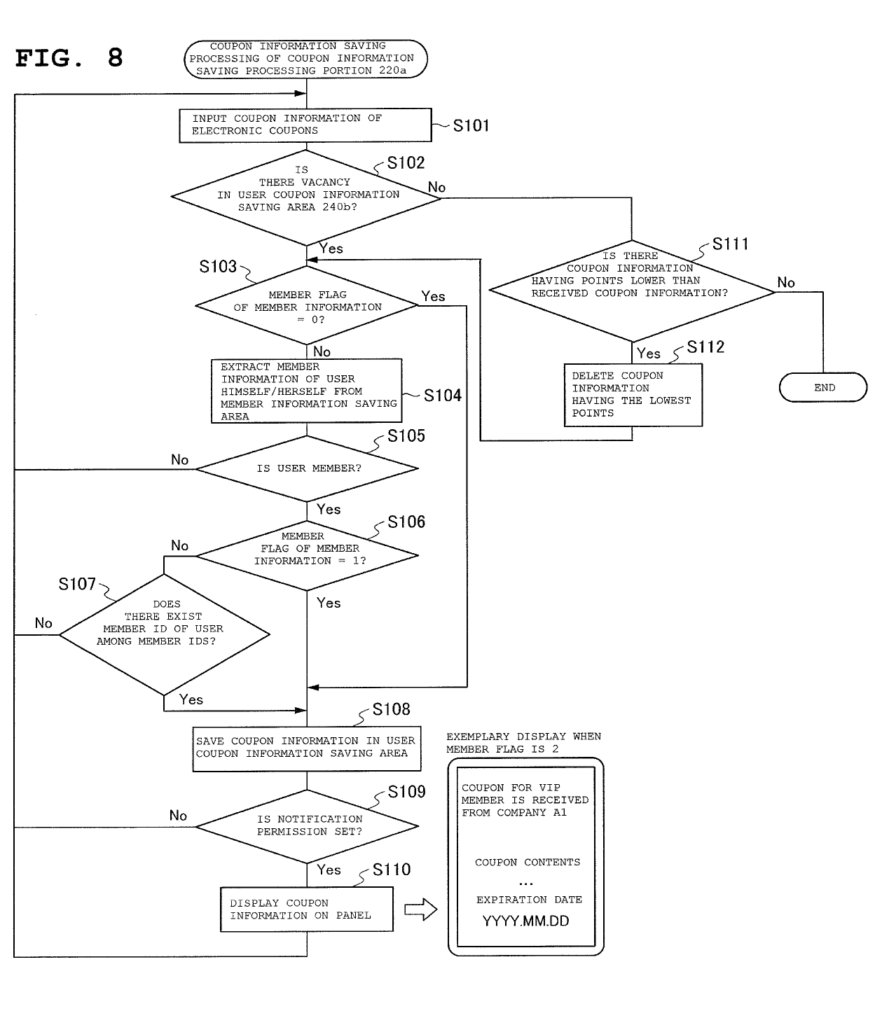

Next, description will be given for coupon information saving processing executed by the coupon information saving processing portion 220a of the mobile information terminal 200. The broadcast reception terminal 100 transmits coupon information in the coupon information saving area 111b to the mobile information terminal 200 in the order of high points. When the wireless communication interface portion 210 of the mobile information terminal 200 receives the coupon information of electronic coupons from the broadcast reception terminal 100, the control portion 220 is notified that the coupon information of the electronic coupons is received. When the control portion 220 inputs this notification, the control portion 220 activates the coupon information saving processing portion 220a. When the coupon information saving processing portion 220a is activated, the coupon information saving processing portion 220a starts coupon information saving processing. Description will be given below in the order of steps shown in a flowchart of coupon information saving processing of FIG. 8.

(Step S101)

First, the coupon information saving processing portion 220a inputs coupon information of electronic coupons from the wireless communication interface portion 210.

(Step S102)

Subsequently, the coupon information saving processing portion 220a confirms whether there is vacancy in the user coupon information area 240b. When there is vacancy (Yes at step S102), the procedure moves to step S103. Further, when there is no vacancy (No at step S102), the procedure moves to step S111.

(Step S111)

In the case of No at step S102, the coupon information saving processing portion 220a confirms whether there is coupon information having lower points than the received coupon information in the user coupon information area 240b. When there is no coupon information having lower points (No at step S111), the coupon information is not able to be saved any more even if being received, so that communication with the broadcast reception terminal 100 is finished as well as the coupon information saving processing is finished. When there is coupon information having lower points (Yes at step S111), the procedure moves to step S112.

(Step S112)

In the case of Yes at step S111, coupon information having the lowest points in the user coupon information area 240b is deleted and the procedure moves to step S103.

(Step S103)

In the case of Yes at step S102, the coupon information saving processing portion 220a judges whether a member flag set to member information of the coupon information is 0. When the member flag is 0 (Yes at step S103), the procedure moves to step S108. When the member flag is not 0 (No at step S103), the procedure moves to step S104.

(Step S104)

In the case of No at step S103, the coupon information saving processing portion 220a extracts member information of a user himself/herself from the member information saving area 240a of the storage portion 240.

(Step S105)

Subsequently, the coupon information saving processing portion 220a judges whether to be a member of a company or a store of the coupon information from the member information of the user himself/herself, which is extracted at step S104. When the user is a member of the company or the store of the coupon information (Yes at step S105), the procedure moves to step S106. When the user is not a member of the company or the store of the coupon information (No at step S105), the procedure returns to step S101.

(Step S106)

In the case of Yes at step S105, the coupon information saving processing portion 220a judges whether the member flag set to the member information of the coupon information is 1. When the member flag is 1 (Yes at step S106), the procedure moves to step S108. When the member flag is not 1 (No at step S106), the procedure moves to step S107.

(Step S107)

In the case of No at step S106, the coupon information saving processing portion 220a judges whether there exists a member ID of the user himself/herself among member IDs set in the member information of the coupon information. When there exists the member ID of the user himself/herself among the member IDs set in the member information of the coupon information (Yes at step S107), the procedure moves to step S108. When there is no member ID of the user himself/herself among the member IDs set in the member information of the coupon information (No at step S107), the procedure returns to step S101.

(Step S108)

In the case of Yes at step S103, step S106 and step S107, the coupon information saving processing portion 220a saves the coupon information of the electronic coupons in the user coupon information saving area 240b.

(step S109)

Subsequently, the coupon information saving processing portion 220a judges whether notification permission of the coupon information of the electronic coupons received by the mobile information terminal 200 is set by the user to the panel operation display portion 230. When notification permission is set (Yes at step S109), the procedure moves to step S110. When notification permission is not set (No at step S109), the procedure returns to step S101.

(Step S110)

In the case of Yes at step S109, the coupon information saving processing portion 220a displays the coupon information of the electronic coupons on the panel of the panel operation display portion 230. For example, when the member flag is 2, “A coupon for a VIP member is received from a company A1. Coupon contents . . . expiration date YYYY.MM.DD is displayed.”

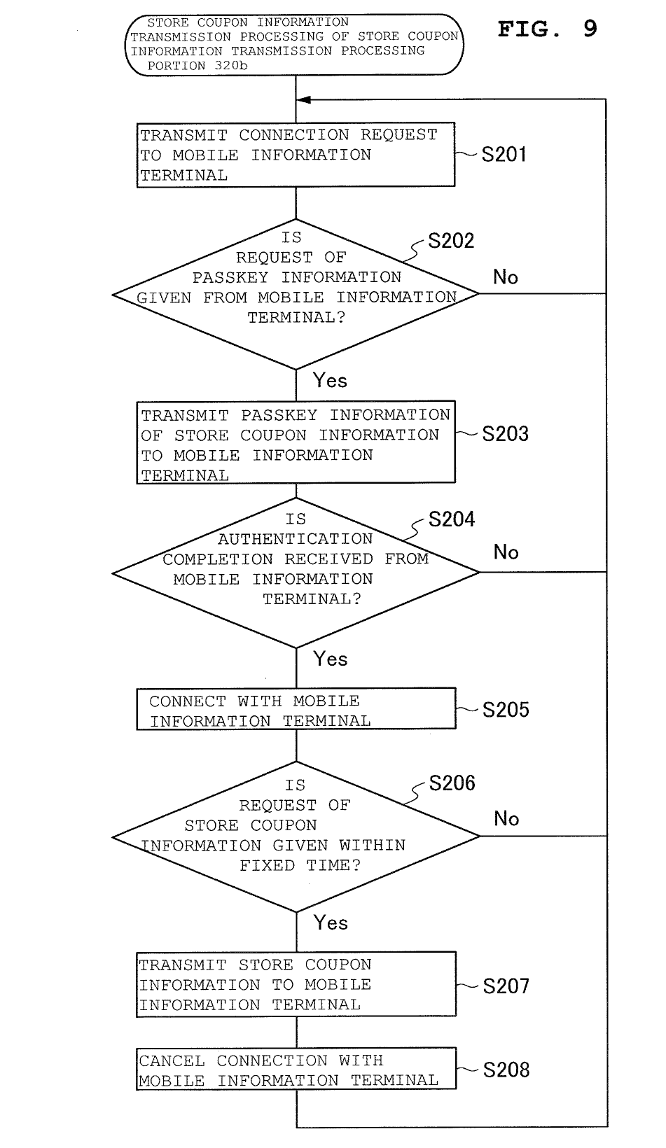

Next, description will be given for store coupon information transmission processing executed by the store coupon information transmission processing portion 320b of the store coupon information processing terminal 300. When power is input to the store coupon information processing terminal 300, the control portion 320 starts control of the entire store coupon information processing terminal 300. When the control portion 320 starts the control, the control portion 320 activates the store coupon information transmission processing portion 320b. When the store coupon information transmission processing portion 320b is activated, the store coupon information transmission processing portion 320b starts store coupon information transmission processing. Description will be given below in the order of steps shown in a flowchart of store coupon information transmission processing of FIG. 9.

(Step S201)

First, the store coupon information transmission processing portion 320b transmits a connection request to the mobile information terminal 200 via the wireless communication interface portion 340.

(Step S202)

Subsequently, the store coupon information transmission processing portion 320b judges whether there is a request of passkey information from the mobile information terminal 200. When there is a request of passkey information (Yes at step S202), the procedure moves to step S203. When there is no request of passkey information (No at step S202), the procedure returns to step S201.

(Step S203)

In the case of Yes at step S202, the store coupon information transmission processing portion 320b extracts the passkey information of store coupon information from the store coupon information saving area 330a of the storage portion 330 to transmit to the mobile information terminal 200.

(Step S204)

Subsequently, the store coupon information transmission processing portion 320b judges whether authentication completion is received from the mobile information terminal 200. When authentication completion is received (Yes at step S204), the procedure moves to step S205. When authentication completion is not received (No at step S204), the procedure returns to step S201.

(Step S205)

In the case of Yes at step S204, the store coupon information transmission processing portion 320b performs connection with the mobile information terminal 200. By connecting with the mobile information terminal 200 in this manner, transmission and reception of data are enabled between the store coupon information processing terminal 300 and the mobile information terminal 200 by wireless communication.

(Step S206)

Subsequently, the store coupon information transmission processing portion 320b judges whether a request of store coupon information is given from the mobile information terminal 200 within a fixed time. When the request of the store coupon information is given (Yes at step S206), the procedure moves to step S207. When the request of the store coupon information is not given (No at step S206), the procedure returns to step S201.

(Step S207)

In the case of Yes at step S206, the store coupon information transmission processing portion 320b extracts the store coupon information from the store coupon information saving area 330a of the storage portion 330 to transmit to the mobile information terminal 200.

(Step S208)

Subsequently, the store coupon information transmission processing portion 320b cancels the connection with the mobile information terminal 200 and the procedure returns to step S201 where a connection request is transmitted to the mobile information terminal 200. By cancelling the connection with the mobile information terminal 200 in this manner, transmission and reception of data are disabled between the store coupon information processing terminal 300 and the mobile information terminal 200 by wireless communication.

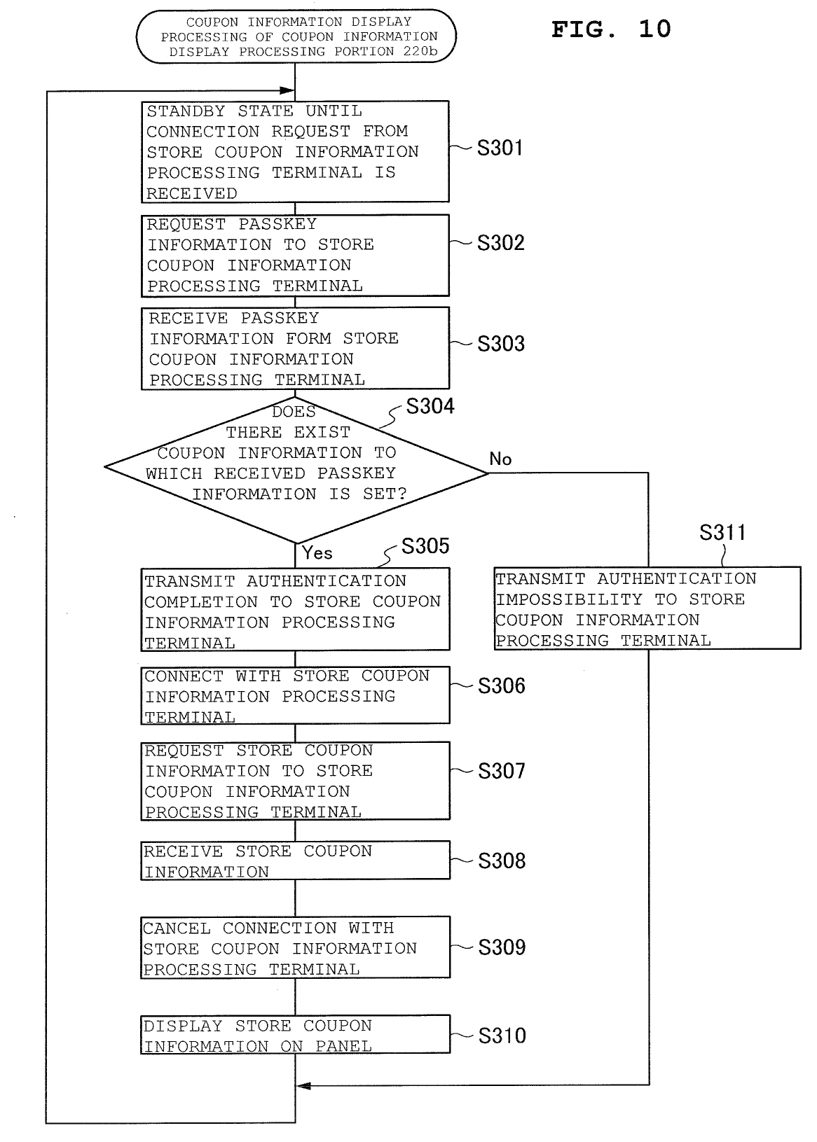

Next, description will be given for coupon information display processing executed by the coupon information display processing portion 220b of the mobile information terminal 200. When power is input to the mobile information terminal 200, the control portion 220 starts control of the entire mobile information terminal 200. When the control portion 220 starts the control, the control portion 220 activates the coupon information display processing portion 220b. When the coupon information display processing portion 220b is activated, the coupon information display processing portion 220b starts coupon information display processing. Description will be given below in the order of steps shown in a flowchart of coupon information display processing of FIG. 10.

(Step S301)

First, the coupon information display processing portion 220b is in a standby state. When a user, being in possession of the mobile information terminal 200, comes into a range where the mobile information terminal 200 and the store coupon information processing terminal 300 are allowed to perform wireless communication by short distance wireless communication means such as Bluetooth (registered trademark) or ZigBee (registered trademark), the wireless communication interface portion 210 of the mobile information terminal 200 receives a connection request transmitted from the store coupon information processing terminal 300. When the wireless communication interface portion 210 of the mobile information terminal 200 receives this connection request, the control portion 220 is notified. When the control portion 220 inputs this notification, the standby state of the coupon information display processing portion 220b is cancelled and the coupon information display processing portion 220b receives the connection request from the mobile information terminal 200.

(Step S302)

First, the coupon information display processing portion 220b requests passkey information to the store coupon information processing terminal 300 via the wireless communication interface portion 210.

(Step S303)

Subsequently, the coupon information display processing portion 220b receives the passkey information from the store coupon information processing terminal 300 via the wireless communication interface portion 210.

(Step S304)

Subsequently, the coupon information display processing portion 220b extracts the passkey information of coupon information from the user coupon information saving area 240b of the storage portion 240, and judges whether there exists coupon information to which passkey information same as the passkey information received from the store coupon information processing terminal 300 is set. When there exists the coupon information to which the passkey information same as the passkey information received from the store coupon information processing terminal 300 is set (Yes at step S304), the procedure moves to step S305. When there does not exist the coupon information to which the passkey information same as the passkey information received from the store coupon information processing terminal 300 is set (No at step S304), the procedure moves to step S311.

(Step S305)

In the case of Yes at step S304, the coupon information display processing portion 220b transmits authentication completion to the store coupon information processing terminal 300 via the wireless communication interface portion 210.

(Step S306)

Subsequently, the coupon information display processing portion 220b performs connection with the store coupon information processing terminal 300. By connecting with the store coupon information processing terminal 300 in this manner, transmission and reception of data are enabled between the mobile information terminal 200 and the store coupon information processing terminal 300 by wireless communication.

(Step S307)

Subsequently, the coupon information display processing portion 220b transmits a request of store coupon information via the wireless communication interface portion 210 to the store coupon information processing terminal 300.

(Step S308)

Subsequently, the coupon information display processing portion 220b receives the store coupon information from the store coupon information processing terminal 300 via the wireless communication interface portion 210.

(Step S309)

Subsequently, the coupon information display processing portion 220b cancels the connection with the store coupon information processing terminal 300. By cancelling the connection with the store coupon information processing terminal 300 in this manner, transmission and reception of data are disabled between the mobile information terminal 200 and the store coupon information processing terminal 300 by wireless communication.

(Step S310)

Subsequently, the coupon information display processing portion 220b displays the store coupon information on the panel of the panel operation display portion 230, and the procedure returns to step S301 where the state is in standby until a connection request is received from the store coupon information processing terminal 300.

(Step S311)

In the case of No at step S304, the coupon information display processing portion 220b transmits authentication impossibility to the store coupon information processing terminal 300 via the wireless communication interface portion 210, and the procedure returns to step S301 where the state is in standby until a connection request is received from the store coupon information processing terminal 300.

According to such an embodiment, the electronic coupon system 10 is automatically able to acquire filter information from operation information or the like for the broadcast reception terminal 100 or the mobile information terminal 200, extract only an electronic coupon having a high likelihood of being used by a user from a lot of electronic coupons delivered by digital broadcast radio waves with these filter information, and save it in the mobile information terminal 200 of the user. Further, if the user, being in possession of the mobile information terminal 200 in which the electronic coupon is saved, approaches the store 14 where a service of the electronic coupon is able to be received, coupon information of the electronic coupon available at the store 14 is received by the mobile information terminal 200 automatically with short distance wireless communication means such as Bluetooth (registered trademark) or ZigBee (registered trademark) and displayed on the panel of the panel operation display portion 230, so that the user is able to use the electronic coupon without forgetting.

Note that, according to the present embodiment, though description has been given for an example in which there is one mobile information terminal 200, but it is also possible to provide a plurality of pieces. In such a case, the same is able to be realized by providing the filter information acquisition processing portion 110a, the coupon information point setting processing portion 110b and the coupon information transmission processing portion 110c of the broadcast reception terminal 100 for each of the mobile information terminals 200.

Moreover, according to the present embodiment, description has been given for an example in which, as to passkey information which is authentication information for performing wireless communication by the mobile information terminal 200 and the store coupon information processing terminal 300, the passkey information is set to coupon information in advance, however, generating from other information set to the coupon information is also possible. For example, company information and target merchandise information set to the coupon information may also serve as passkey information with bitwise exclusive OR (XOR). Further, according to the present embodiment, though description has been given for an example in which the store coupon information reception processing portion 320a receives, from a server or an HP (homepage) of other stores and companies connected to the network 400 or the like, coupon information of an electronic coupon available at its own store 14 in the store coupon information processing terminal 300, it is also possible that coupon information of an electronic coupon available at the store 14 is saved in advance in the store coupon information processing terminal 300 or extracted from digital broadcast radio waves. In addition, according to the present embodiment, though description has been given for an example of electronic coupons delivered by digital broadcast radio waves such as terrestrial digital broadcasting and satellite digital broadcasting, it is possible to be applied to electronic coupons delivered by broadcast signals passed by various broadcasting means such as CATV broadcasting, IP broadcasting, internet broadcasting, and regional wireless LAN broadcasting.

As described above, the electronic coupon system of the present invention is able to provide an electronic coupon system in which, as to an electronic coupon delivered by digital broadcast radio waves, even when an electronic coupon having a high likelihood of being used by a customer changes, only an electronic coupon having a high likelihood of being used by the customer is able to be extracted from the digital broadcast radio waves in accordance with the change and the electronic coupon is usable without being forgot at a store where the electronic coupon is usable by the customer.

As above, though the present invention has been described with the specific embodiments, the above-described embodiments are illustrative of the present invention, and, needless to say, it is not limited to these embodiments.

### INDUSTRIAL APPLICABILITY

The present invention is suitable for an electronic coupon system, but is also applicable to a general system in which not only a coupon but a gift certificate, a complimentary ticket, an admission ticket or the like is automatically delivered.

### REFERENCE SIGNS LIST

10 . . . electronic coupon system
11 . . . broadcasting station
12 . . . user home
13 . . . access point
14 . . . store
100 . . . broadcast reception terminal
101 . . . digital tuner
102 . . . TS (Transport Stream) decoder
103 . . . audio processing portion
104 . . . video processing portion
105 . . . data broadcast processing portion
106 . . . OSD processing portion
107 . . . display processing portion
108 . . . television monitor
109 . . . coupon information processing portion
110 . . . control portion
110a . . . filter information acquisition processing portion
110b . . . coupon information point setting processing portion
110c . . . coupon information transmission processing portion
111 . . . storage portion
111a . . . filter information saving area
111b . . . coupon information saving area
112 . . . wireless communication interface portion
113 . . . LAN interface portion
114 . . . system bus
200 . . . mobile information terminal
210 . . . wireless communication interface portion
220 . . . control portion
220a . . . coupon information saving processing portion
220b . . . coupon information display processing portion
230 . . . panel operation display portion
240 . . . storage portion
240a . . . member information saving area
240b . . . user coupon information saving area
300 . . . store coupon information processing terminal
310 . . . internet communication portion
320 . . . control portion
320a . . . store coupon information reception processing portion
320b . . . store coupon information transmission processing portion
330 . . . storage portion
330a . . . store coupon information saving area
340 . . . wireless communication interface portion
400 . . . network

1. An electronic coupon system, comprising a broadcast reception terminal, a store coupon information processing terminal and a mobile information terminal, wherein
the broadcast reception terminal has
coupon information extraction means for extracting coupon information of electronic coupons from a broadcast signal,
filtering means for filtering the electronic coupons, and
coupon information transmission means for transmitting the coupon information of the electronic coupons subjected to filtering by the filtering means to the mobile information terminal,
the store coupon information processing terminal has
store coupon information transmission means for transmitting store coupon information to the mobile information terminal, and
the mobile information terminal has
store coupon information display means for displaying the store coupon information on the mobile information terminal when the coupon information received from the broadcast reception terminal and the store coupon information received from the store coupon information processing terminal are matched.

2. The electronic coupon system as defined in claim 1, wherein the filtering means sets points for each of the electronic coupons based on filter information acquired from the broadcast reception terminal and the mobile information terminal, and performs filtering of the electronic coupons based on the points.

3. The electronic coupon system as defined in claim 2, wherein a weight rank is set to the filter information, and the points of the electronic coupons are calculated by the weight rank.

4. The electronic coupon system as defined in claim 3, wherein the store coupon information processing terminal transmits a connection request to the mobile information terminal, the mobile information terminal receives the connection request from the store coupon information processing terminal, and when authentication is completed, the store coupon information processing terminal and the mobile information terminal are connected.

5. The electronic coupon system as defined in claim 4, wherein the store coupon information processing terminal and the mobile information terminal are connected by short distance wireless communication means.

6. The electronic coupon system as defined in claim 4, wherein authentication of the store coupon information processing terminal and the mobile information terminal is performed by collation of passkey information set to the coupon information and passkey information set to the store coupon information.

7. The electronic coupon system as defined in claim 6, wherein whether the coupon information and the store coupon information are matched is judged by collation of the passkey information.

8. The electronic coupon system as defined in claim 7, wherein the passkey information of the coupon information is generated from the coupon information.

9. The electronic coupon system as defined in claim 7, wherein the passkey information of the store coupon information is generated from the store coupon information.

10. The electronic coupon system as defined in claim 1, wherein the mobile information terminal judges whether a user of the mobile information terminal is able to use the electronic coupons with member information set to the coupon information.

11. A broadcast reception terminal capable of communication with a mobile information terminal, comprising
coupon information extraction means for extracting coupon information of electronic coupons from a broadcast signal,
filtering means for acquiring filter information based on at least any one of a program received by the broadcast reception terminal, data broadcasting and operation information by the mobile information terminal, and performing filtering of the coupon information of the electronic coupons by using the acquired filter information, and
coupon information transmission means for transmitting the coupon information of the electronic coupons subjected to filtering by the filtering means to the mobile information terminal.

12. The broadcast reception terminal as defined in claim 11, wherein the filtering means sets points for each of the coupon information of the electronic coupons based on the acquired filter information, and performs filtering of the coupon information of the electronic coupons based on the set points.

13. The broadcast reception terminal as defined in claim 12, wherein a weight rank is set to the filter information, and the points of the coupon information of the electronic coupons are calculated by the weight rank.

14. The broadcast reception terminal as defined in claim 11, wherein the coupon information of the electronic coupons transmitted to the mobile information terminal includes passkey information for the mobile information terminal to judge whether to be available at a store provided with a store coupon information processing terminal.

15. A mobile information terminal that receives electronic coupons from the broadcast reception terminal as defined in claim 11.

16. A mobile information terminal including store coupon information notification means for notifying store coupon information when the coupon information of the electronic coupons received from the broadcast reception terminal as defined in claim 11 is available at a store provided with a store coupon information processing terminal.

17. A store coupon information processing terminal that is connected with the mobile information terminal as defined in claim 15 by short distance wireless communication means.

18. A mobile information terminal capable of communication with a broadcast reception terminal and a store coupon information processing terminal, wherein
store coupon information notification means for acquiring filter information from at least any one of a program received by the broadcast reception terminal, data broadcasting and operation information by the mobile information terminal, which is coupon information of electronic coupons received from the broadcast reception terminal, and, when the coupon information of the electronic coupons subjected to filtering using the acquired filter information is available at a store provided with a store coupon information processing terminal, notifying the store coupon information is included.

19. A store coupon information processing terminal capable of communication with a mobile information terminal, wherein
store coupon information transmission means for acquiring filter information from at least any one of a program received by a broadcast reception terminal, data broadcasting and operation information by the mobile information terminal, which is coupon information of electronic coupons saved in the mobile information terminal, and, when the coupon information of the electronic coupons subjected to filtering using the acquired filter information is available at a store provided with a store coupon information processing terminal, transmitting the store coupon information to the mobile information terminal for notifying the store coupon information to the mobile information terminal.
